(19) United States
(12) Patent Application Publication
(10) Pub. No.: US 2008/0055306 A1
(43) Pub. Date: Mar. 6, 2008

(54) VIRTUAL THREE-DIMENSIONAL ENVIRONMENT

(76) Inventors: William Ming Yi Kwok, San Jose, CA (US); Leon Papkoff, San Jose, CA (US); Conrad Rushing, San Jose, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/850,539

(22) Filed: Sep. 5, 2007

Related U.S. Application Data
(60) Provisional application No. 60/824,605, filed on Sep. 5, 2006.
(60) Provisional application No. 60/824,889, filed on Sep. 7, 2006.

(51) Int. Cl. G06T 15/00; G06F 3/048; G06T 15/20

(52) U.S. Cl. 345/419; 320/101; 705/1; 715/848

(57) ABSTRACT

A virtual space and apparatus for constructing, displaying, and interacting with the virtual space. The virtual space may take the form of a tradeshow, complete with exhibit booths, video screens, a convention hall and so forth. In such an exemplary virtual space, the user may navigate between booths, displays, halls and so on. Navigation may be displayed as three-dimensional movement on a two-dimensional display, and may be rendered as real-time motion between booths controlled by the user or as short movies or “cutscenes” showing the motion from one booth (or other point of interest) to another booth (or point of interest). A door is a point or portion of the virtual space that may be accessed or interacted with in order to leave a booth, initiate a transition movie or travel between two parts or segments of the virtual space.

### RELATED APPLICATIONS

This application claims priority to U.S. Provisional Application No. 60/824,605, filed Sep. 5, 2006, and U.S. Provisional Application No. 60/824,889, filed Sep. 7, 2006, the entire disclosures of which are incorporated herein by reference.

### BACKGROUND OF THE INVENTION

1. Technical Field

The present invention relates generally to a three-dimensional virtual environment and, more particularly, to an interactive three-dimensional environment accessible remotely.

2. Background Art

The explosion of computer technology, and particularly computer-assisted communications technology, has led to a shift in human interaction. Rather than sending a letter by post, calling another person on the telephone or conducting an in-person meeting, many people now use electronic mail, voice over Internet Protocol technologies or virtual meeting technologies instead. The widespread adoption of computers and computer networking have changed human communication.

Additionally, the business and economic climate of both the United States and the world has led to a decrease in extraneous spending. Many companies, for example, are cutting back on employee travel and training costs. This, in turn, forces several companies to carefully pick and choose which employees may be sent to certain training programs, tradeshows, professional meetings and so forth. Although reducing employee attendance at these events may likewise reduce operating expenses for companies, it also may lead to a less-educated and/or less-networked workforce.

One possible solution is to provide training and networking opportunities through the aforementioned computer-assisted communications technology. However, such communications technologies generally are not especially immersive and do not replicate the experience of meeting in person. Accordingly, there is a need in the art for an improved virtual environment.

### SUMMARY OF THE INVENTION

Generally, one embodiment of the present invention takes the form of a virtual three-dimensional space. The environment may be rendered, for example, on a display such as a computer display screen, television, mobile phone screen, personal digital assistant (PDA) screen, handheld game screen, and so forth. As used herein, a “virtual three-dimensional space” or more simply “virtual space” refers to a model of a three-dimensional space, typically presented on a two-dimensional computer display to resemble or mimic a three-dimensional space.

This virtual space may be accessed across a network, such as the Internet, from any computer or computing device connected to the network. For example, the virtual space may be displayed in a single World Wide Web (WWW) enabled browser window or a custom program designed to access the virtual space.

The virtual space may replicate, create or display any three-dimensional space desired, whether real or imagined. For example, the virtual space may take the form of a tradeshow, complete with exhibit booths, video screens, a convention hall and so forth. In such an exemplary virtual space, the user may navigate between booths, displays, halls and so forth. Typically, although not necessarily, such navigation is also displayed as three-dimensional movement on a two-dimensional display, and may be rendered as real-time motion between booths controlled by the user or as short movies or “cutscenes” showing the motion from one booth (or other point of interest) to another booth (or point of interest). A “door” or “connector,” as generally used herein, refers to a point or portion of the virtual space that may be accessed or interacted with in order to leave a booth, initiate a transition movie or travel between two parts or segments of the virtual space.

### BRIEF DESCRIPTION OF THE FIGURES

FIG. 1 is a block diagram of an exemplary engine of an exemplary embodiment of the present invention.

FIG. 2A depicts a first block model that may be employed by the exemplary embodiment of the invention

FIG. 2B depicts a second block model that may be employed by the exemplary embodiment of the invention.

FIG. 3A depicts the block model of FIG. 2A with a skin applied thereto.

FIG. 3B depicts the block model of FIG. 2B with a skin applied thereto.

FIG. 4 is a diagram showing the relationship between transitions, doors, and objects in accordance with the exemplary embodiment of the invention.

FIG. 5 is a diagram

### DETAILED DESCRIPTION

I. Introduction and Overview

Generally, one embodiment of the present invention takes the form of a virtual three-dimensional space. The environment may be rendered, for example, on a display such as a computer display screen, television, mobile phone screen, personal digital assistant (PDA) screen, handheld game screen, and so forth. As used herein, a “virtual three-dimensional space” or more simply “virtual space” refers to a model of a three-dimensional space, typically presented on a two-dimensional computer display to resemble or mimic a three-dimensional space.

This virtual space may be accessed across a network, such as the Internet, from any computer or computing device connected to the network. For example, the virtual space may be displayed in a single World Wide Web (WWW) enabled browser window or a custom program designed to access the virtual space. Additional exemplary networks include intranets, internets, wireless networks, including infrared, radio-frequency and Bluetooth networks, wired networks, mobile networks, and so forth. Similarly, the virtual space may be accessed by a user employing any of a number of computing devices, including a personal computer, notebook computer, handheld computing device, personal digital assistant, mobile telephone, and so forth.

The embodiment, including the engine, XML file or files and asset library or libraries, may be hosted and operated by any similar computing device(s). Various portions of the embodiment may be hosted by different computing devices. For example, the user's interface may be hosted by a first computing device, the engine by a second computing device, and the asset libraries by a third computing device. Each of these devices may be connected to one another by one or more networks.

The virtual space may replicate, create or display any three-dimensional space desired, whether real or imagined. For example, the virtual space may take the form of a tradeshow, complete with exhibit booths, video screens, a convention hall and so forth. In such an exemplary virtual space, the user may navigate between booths, displays, halls and so forth. Typically, although not necessarily, such navigation is also displayed as three-dimensional movement on a two-dimensional display, and may be rendered as real-time motion between booths controlled by the user or as short movies or “cutscenes” showing the motion from one booth (or other point of interest) to another booth (or point of interest). A “door” or “connector,” as generally used herein, refers to a point or portion of the virtual space that may be accessed or interacted with in order to leave a booth, initiate a transition movie or travel between two parts or segments of the virtual space.

A “point of interest” may include a booth, video display, waypoint between booths, or any other point in the virtual three-dimensional space as defined by a creator of the space.

The virtual space may include a number of predefined objects, such as the aforementioned booths and screens. These objects may consist of block models and skins overlapping the block models. In order to simplify construction of the virtual space, the block models may be predefined. For example, a number of different block model structures may exist and any of these structures may be placed at a particular point in the virtual space. A skin or graphic overlay may be placed over the block model to customize the look of each object. Multiple block model objects may be placed side-by-side, or attached to one another, in order to create a larger object. By employing predefined objects, rendering, display and navigation of the virtual space may be made easier and less resource-intensive. Further, creation of the virtual space may be simpler and quicker if block model objects are used. It should be noted that other predefined objects may be used in addition to, or instead of, block model objects.

Media presentations, such as streaming or downloadable content, may be integrated into the virtual space. For example, a booth may have a selectable area defined therein. Clicking or otherwise selecting this area may initiate streaming or downloading of a video or audio presentation. The media presentation may be displayed within the selectable area, elsewhere within the window or application displaying the virtual space, or in a separate window/application. Thus, the media presentation may be integrated with, and presented as part of, the virtual space instead of appearing as an external link or segment tangentially related to the virtual space.

In addition, users may have the opportunity to download certain files, such as documents, media presentations, pictures, screensavers, product brochures or information, and so forth while navigating or otherwise interacting with the virtual space. For example, a user may click, select or otherwise interact with a portion of the virtual space (a “download initiator”) and, in response, receive the option to download a file. The download initiator may be accessible every time a particular segment or area of the virtual space is accessed. For example, the download initiator may be a selectable spot on a booth. Alternatively, the initiator may be accessible only if certain actions are taken in advance, or at certain times. As an example, the download initiator may be embedded in streaming media presented in the virtual environment and present only for a specific part or time of the media. As yet another alternative, the download initiator may be unlocked by performing specific actions, such as visiting one or more segments of the virtual space. In certain embodiments of the invention, the various files selected for download may be aggregated into a single compressed file, such as a ZIP file, and downloaded at the user's discretion.

Some exemplary embodiments of the invention include an aggregator and/or tracker to systematize and keep track of downloaded files. As an example, an exemplary embodiment may include a “gift bag” of sorts that displays the various files available for download or already downloaded. The gift bag may index and/or present the files according to file type, the source of the file (i.e., from which booth or section of the virtual space the download was initiated), or content of the file (i.e., whether the file is a screensaver, product brochure, media and so forth). Thus, the user may quickly and easily review which files he has downloaded or selected for download.

Having discussed overviews of various exemplary features and embodiments, particular features, implementations, embodiments and so forth will now be described.

II. Engine

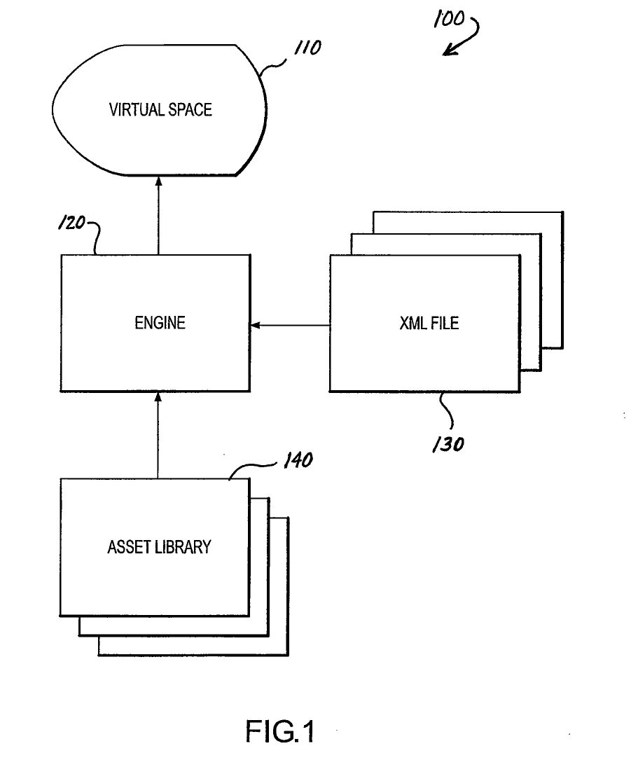

FIG. 1 depicts an embodiment of an apparatus 100 for implementing a virtual space 110, in block diagram form, particularly showing the interaction between the an engine 120, data files 130, and an asset library 140 including various assets used to create the virtual three-dimensional space 110. Broadly, an exchange markup language (XML) file contains definitions and data regarding various objects included in the virtual space, as well as their locations. “Locations” or “positions,” as used herein, do not necessarily refer to the positioning or location of an object in a Cartesian three-dimensional space. Instead, such locations or positions may be relative and defined only with respect to other objects. As an example, two objects may be defined in the virtual space with a door leading between the two. A “door” generally is a transition area from one object to another. That is, if a door is accessed, the engine changes the display of the virtual space so that the present object is replaced with the other object associated with the door. This is described in more detail below, but a brief example may aid in understanding.

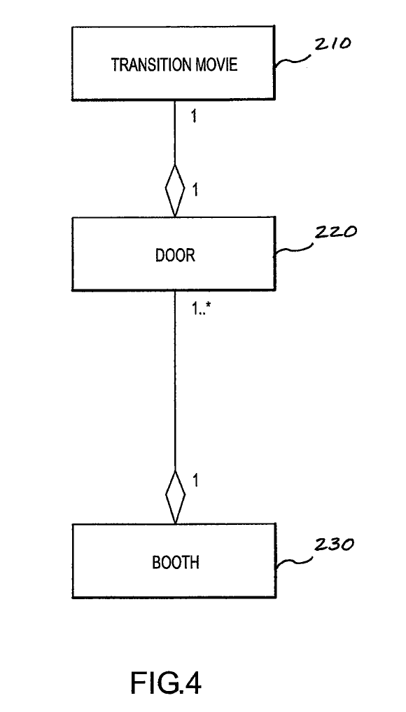

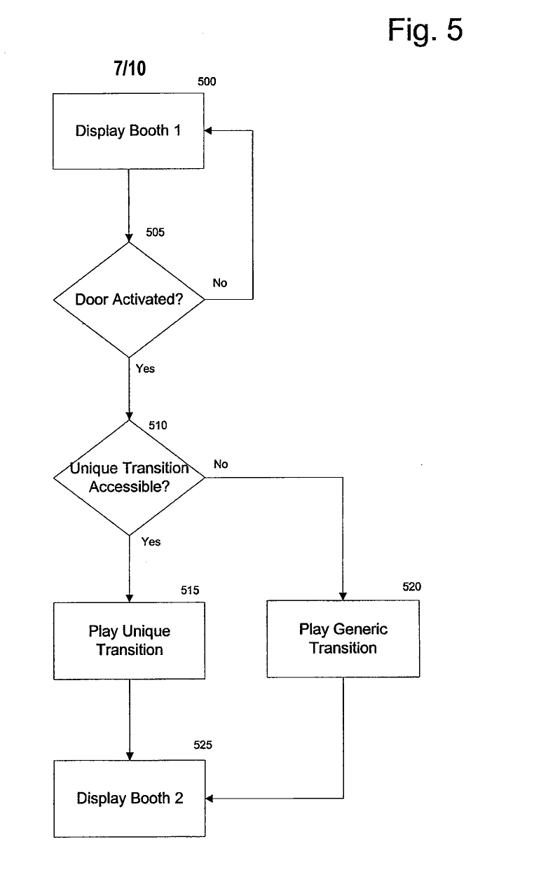

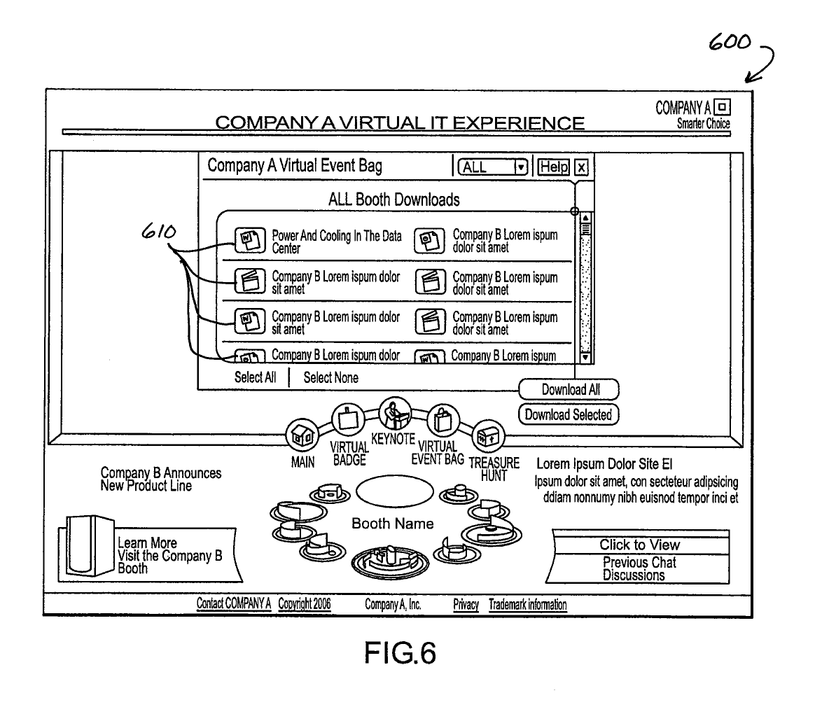

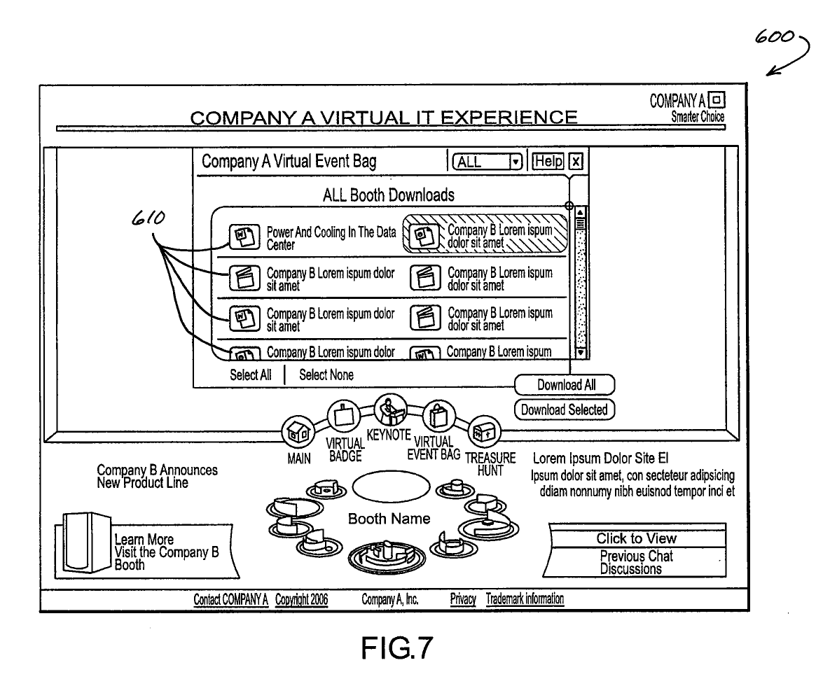

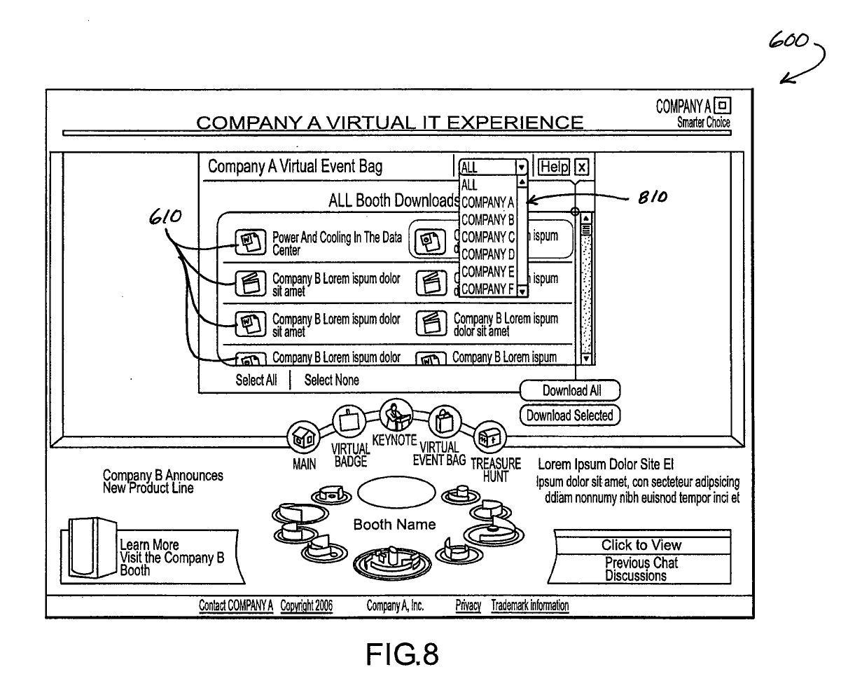

Presume a first object is displayed by the engine in a user's browser. A door may be defined within the object or otherwise associated with the object. Selecting, clicking or otherwise activating the door may instruct the engine to display a second object to which the door leads instead of the first object. This is explained in more detail, below, with respect to FIGS. 4 and 5. Insofar as the objects are linked by doors and transition between objects (or positions) may be accomplished in certain embodiments only by means of these doors, the positioning of each object is defined only relative to other objects. That is, the relationship/position of each object is defined by the doors connected to that object and, in turn by the other objects to which such doors lead.

Returning to FIG. 1, the objects to be used (e.g., displayed) in the virtual space may be called from an XML file in the asset library 140 and rendered at the coordinates specified in the XML file by the engine 120. Alternatively, the library may be omitted and all objects may be fully specified in the XML file 130. By using the data in the XML file, the engine 120 may render various booths, doors, transition points, movies, etc. to create the virtual space 110.

The virtual space 110 may be of any size and/or configuration and is generally limited only by the computing parameters, such as processing unit power and functionality, available memory, available storage and so forth accessible by the computing device accessing the virtual space 110.

In one exemplary embodiment, the engine 120 may be an ActionScript engine built, designed and/or customized to process Flash commands, applications and files, such as those common to the FLASH integrated development environment provided by Adobe Systems, Incorporated of San Jose, Calif. Alternative embodiments of the engine 120 may execute or parse OpenGL commands or scripts (together, “commands”), JavaScript commands, or any other computer-readable command sets that facilitate the display of, rendering of, and/or interaction with graphics and/or animation. In yet another exemplary embodiment of the present invention, the engine 120 may compile, create, display and/or permit interaction with the virtual space 110 based solely on HTML commands.

As previously mentioned and shown in FIG. 1, the engine 120 may interface with both the asset library 140 and XML file(s) 130. The XML file may generally instruct the engine as to which assets are associated with a particular object (such as a booth). Assets may include object dimensions, door dimensions, the background of the object, and so forth. “Dimensions,” as used herein, generally refer to dimensions of the object, door or other element (such as a media clip) on a display screen rather than physical dimensions.

The XML file may also specify, for a given object, its reference name so that the engine may retrieve the booth block model from one of the asset libraries. (It should be noted that either multiple asset libraries or a single asset library may be employed in various embodiments of the invention.) Thus, in the present exemplary embodiment, the XML frame generally contains the data and pointers to other files/asset libraries necessary to construct, render and display the virtual space. The engine employs this data to present the virtual space to the user. Assets are thus pulled dynamically from the asset libraries in accordance with the details of the XML file. By dynamically pulling assets, programmers of the virtual space may relatively easily make changes to the XML file and/or asset libraries, and thus to the virtual space, without necessitating recompiling of code or changing the engine. In addition, and as discussed in more detail below, the separation of assets and object/spatial definitions (such as the data in the XML file) from the engine permits scalability of the virtual space.

An exemplary XML file showing exemplary XML data to create an exemplary virtual space is set forth in Appendix A to this application, which is incorporated herein by reference as if fully set forth. It should be understood that this XML file is illustrative rather than limiting, and contains only a single representation of data to be used by the engine. Further, as mentioned above, alternative embodiments may employ file types other than XML files to store such data.

Certain embodiments of the present invention may present the virtual space 110 in first-person view within the window or browser, while alternative embodiments may present the virtual space 110 in a third-person or over-the-shoulder view. A first-person view may enhance perceived immersiveness of the virtual space 110.

III. Block Models and Skinning

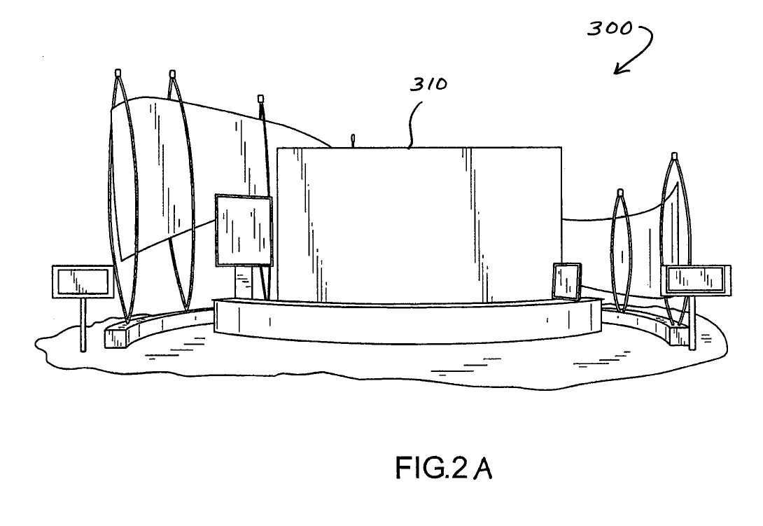

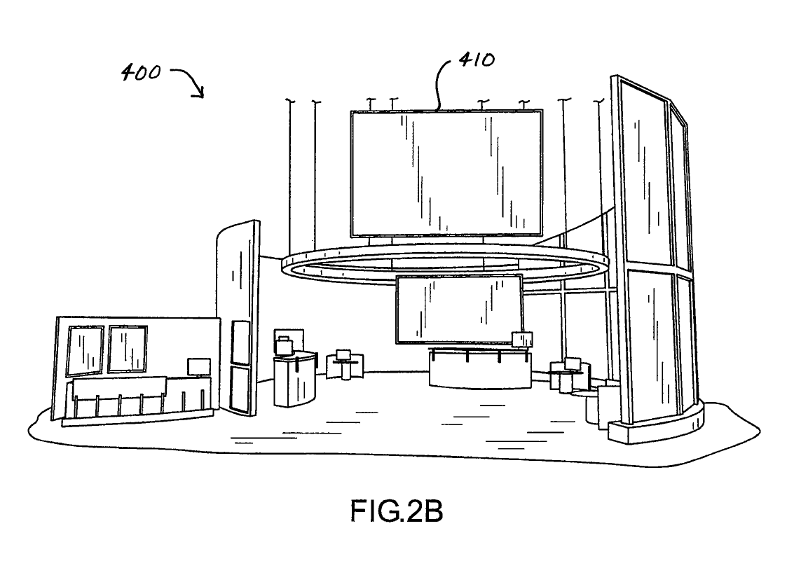

As mentioned previously, each object in the virtual space may consist of a block model and a skin overlaying the block model. The block models are typically stored in an asset library; the exact block model retrieved to be skinned and placed in the virtual environment is specified in the XML file (or other similar data file). FIGS. 2A and 2B, for example, depict two different unskinned booths 300, 400. The block models 310, 410 of booths 300, 400 generally show the shape and three-dimensional characteristics of the booths 300, 400 but do have blank (or generic) textures. The block models 310, 410 may have basic color information in many embodiments. Such color information may be added through an appropriate three-dimensional rendering program, such as Maya, 3DS Max, and so forth.

In alternative embodiments, wire frames of booths or other objects may be used instead of block models.

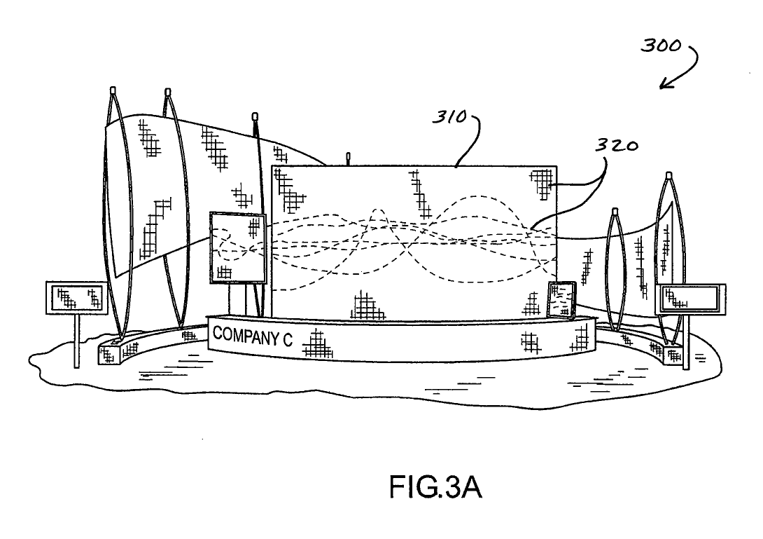

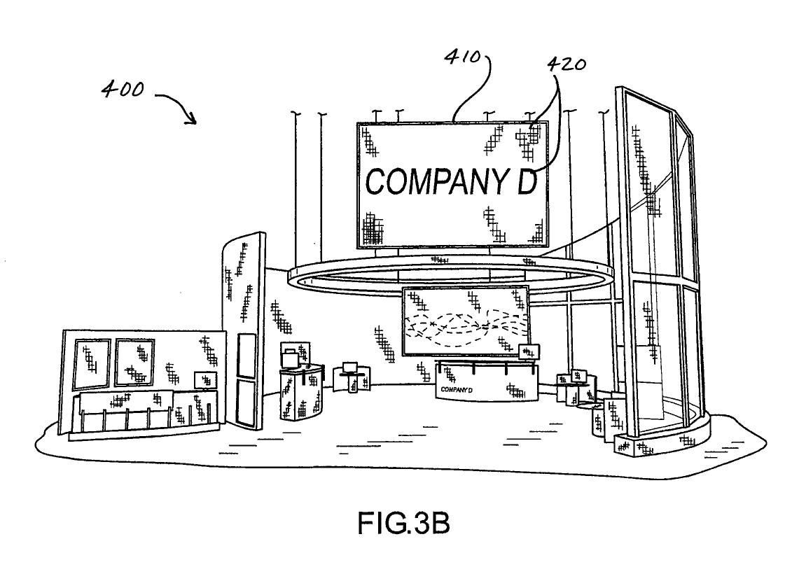

FIGS. 3A and 3B depicts the block models 310, 410 of FIGS. 2A and 2B, respectively, with skins 320, 420 (i.e., textures) applied thereto. The skins 320, 420 are separate assets specified in the XML file and may be dynamically called by the engine to overlay the block models 310, 410. Additionally, and as also shown in FIGS. 2A and 2B, a background and foreground may be specified in the XML file and applied to the block models 310, 410.

It should be noted that no absolute size is required for each block model 310, 410. A default size may be associated, but is not necessary. Instead, the XML file may include size information for each block model 310, 410. Size information may be supplied for each skin 320, 420 as well, or the engine may dynamically size the skin 320, 420 to fit the specified size of the block model 310, 410. The same is true for the foreground and background.

Objects may be defined by attaching a class to the block model. Typically, although not necessarily, the class is a Flash class or Java class. New objects may be created or positioned in the virtual space by calling the class of the object, giving relational data of the object (such as the existence of any doors between the object and another object or actual coordinates in the virtual space), skinning the object and adding any lighting or texturing features that may be desired.

IV. Scalability

In an exemplary embodiment the block models, textures, doors and relative positioning data of models and doors are all stored separately from the engine 120. The engine 120 may retrieve models and textures (as well as media and cutscenes, as discussed below) from various asset libraries 140.

By separating the data from the engine 120, changes may be made to the data without affecting the engine 120 or requiring the engine 120 be recompiled. Not only may this make creation of a virtual space 110 quicker and easier, but it permits expansion of a virtual space 110 in a relatively simple manner. To expand a virtual space, additional data defining new objects, doors, transitions and similar spatial relationships may be added to the XML file 130. Likewise, additional object block models, textures, media, doors, cutscenes and so forth may be added to the asset libraries 140 and employed in the creation and display of the virtual space 110. In this manner, embodiments of the present invention are extremely scalable; adding new objects or positional data (and thus “expanding” the virtual space) is simplified due to the modular nature of the embodiments.

V. Doors and Cutscenes

In certain embodiments of the present invention, doors define transition points between a first object or position in the virtual space and a second object or position in the virtual space. Doors have no set look and may resemble, for example, a hallway, opening, space between objects, empty space and so forth. The term “door” is used merely for convenience. Selecting, clicking on, or otherwise interacting with a door instructs the engine to retrieve a cutscene, display the cutscene, and advance the user to the position in the virtual space to which the door leads.

FIG. 4 depicts the relationships between cutscenes 210 (or “transition movies”), doors 220 and booths 230 (or any other object). Generally, each cutscene 210 corresponds to a single door 220. Multiple doors 220, however, may correspond to a single booth 230 (or object). Put another way, a given booth/object/position in the virtual space may have multiple doors or exits, each of which leads to a unique booth/object/position. Each of these doors 220 has a single transition movie 210 that is shown when the door 220 is selected. The transition movie 210 consists of video simulating motion between the starting position and ending position to enhance immersiveness in the virtual space. Certain embodiments may omit transition movies if desired, or may omit certain transition movies but keep others.

It should be noted that multiple doors may optionally lead to the same booth, object or position in the virtual space but display different cutscenes in order to enhance immersiveness in the virtual space. For example, if the first position is a first booth in a tradeshow and the second position is a second booth in the tradeshow, a first door may play a first cutscene showing a curving motion past other booths and ending at the second booth, while a second door may play a second cutscene showing motion in a relatively straight line between the booths.

FIG. 5 generally depicts a process that may occur when a user selects or interacts with a door. Broadly, FIG. 5 shows the selection of the door in the booth, selection and display of the corresponding cutscene, and redirection of the engine to the second position with subsequent updating of the display in the application or browser.

The transition process from one object to another begins at operation 500. In operation 500, the embodiment displays a booth or other object, referred to in FIG. 5 as “Booth 1.” It should be understood that “Booth 1” is a generic designation and applies to whatever object is presently displayed by the embodiment in the application or browser.

In operation 505, the embodiment checks to see if the user has selected or otherwise activated a door. If not, the embodiment returns to operation 500 and continues to display Booth 1. If, however, the user has activated a door, the embodiment executes operation 510.

In operation 510, the embodiment determines whether a unique transition, corresponding to the activated door, is accessible. A unique transition may not be accessible for a number of reasons. For example, it may not exist, may be corrupt, may not be accessible by the embodiment, and so forth. The unique transition may be inaccessible due to network bandwidth issues, for example. Further, the unique transition may be considered unavailable if the embodiment may access it but such access would take longer than a specified time. As an example, if the transition is available but downloading and/or displaying it to the user would take several minutes, the transition may be considered inaccessible.

If the unique transition is accessible, the embodiment proceeds to operation 515 and plays the unique transition to the user. Typically this is played or shown in the same window or browser in which Booth 1 is shown. Further, the unique transition generally begins with an image matching (or similar to) that shown to the user when the door was activated in operation 505. Thus, transition from the image shown in operation 505 to the transition movie played in operation 515 is generally seamless.

If the unique transition is not available, a generic transition is played and shown to the user in operation 520. As with operation 515, the generic transition is typically shown or played in the same window or browser that displayed Booth 1 in operation 500.

After either operation 515 or operation 520 is executed, Booth 2 is displayed in the browser or application as operation 525. Booth 2 is the destination object to which the door links. As will be appreciated by those of ordinary skill in the art, if a door associated with Booth 2 is selected, the operations of FIG. 5 are repeated with Booth 2 becoming Booth 1 in operation 500.

VI. Media Presentation

Generally, media may be integrated into various exemplary embodiments of the present invention. By selecting portions of a booth or object, streaming or downloading of media (audio, video or both) may be triggered.

In one exemplary embodiment of the present invention, a video player written in Flash plays Flash Video (.flv) and MP3 (.mp3) files. It progressively downloads the video and stores it in the browser's cache. When the user requests another video and/or before the video is unloaded, the video player will record the playtime and stores it in a Flash cookie (alternatively called a “Shared Object”) with an identifier. The identifier may be the filename of the media or any other suitable identifier that identifies the video piece being played. The Flash cookie may be stored in a directory other than that used to store standard browser cookies and typically is not removed when a user clears his/her cookies through a standard browser operation.

When the video player receives instruction to play a video it will try to find and read a cookie with an identifier matching that of the video piece it's trying to play. If it is found, it will then check the cache to see if there is indeed enough of the video downloaded to resume play at the playtime. If not, the player will start playing the video from the beginning.

VII. Downloads and the “Gift Bag”

As mentioned above, a user may download various files from the virtual space by selecting them. Typically, the user clicks, selects or interacts with a particular spot to select a file for download. The file may be immediately downloaded or queued. If a download file is queued, a compressed file containing all download files selected by the user may be created. As an example, a ZIP file may be created that contains within it each user-selected downloadable file. Thus, if a user desired to download a screensaver, product brochure, media clip and text curriculum vitae, each of these may be placed within a single ZIP file and the single ZIP file downloaded. This may speed up and/or simplify downloading.

A user may review the files 610 selected for download through a “gift bag” interface 600, as shown generally in FIGS. 6-8. It should be noted that the gift bag interface 600 shown in FIGS. 6-8 is exemplary and not limiting; the interface may take many forms and shapes.

The gift bag 600 may display the files 610 selected for download (and/or already downloaded) in a number of ways. FIGS. 6 and 7 shows the gift bag 600 displaying all downloads. By contrast, the gift bag 600 may include a menu 810 to group the files 610 according to the entity who provided the files 610 for download or with whom the files 610 are associated, as shown in FIG. 8. It may alternatively group the files 610 by file type, information contained, or file extension. Further, the gift bag 600 may permit grouping by multiple criteria. For example, the user may first elect to view only files 610 of a certain type. Next, the user may further narrow down the files 610 to be displayed by selecting a particular company to which files 610 of the initially-selected type pertain. These sorting options may permit a user the ability to quickly and easily review what files 610 have been selected for download.

The gift bag 600 may also permit a user to remove files 610 previously selected from download from the download queue. The user may, for example, select a file 610 and delete it or otherwise indicate the file 610 is no longer needed. The embodiment may then remove the file 610 from the queue such that the deleted file no longer is included in the compressed file when the compressed file is downloaded.

Further, the video player employed in certain exemplary embodiments of the present invention may include not only the ability to play, rewind, fast forward, skip and pause video, but also the ability to return to a particular point in a video. As an example, presume a user watches one-third of a video in the embodiment's video player then closes the application or browser. The time at which the user stopped watching the video (in this case, closed the browser) may be stored as a regular cookie or Flash cookie on the user's computing device. The next time the user accesses the video through the embodiment (i.e., through the virtual space), the embodiment may resume the video at the time marked in the cookie.

Pointers to files already downloaded, or to be downloaded, may be stored as entries in a database. The gift bag architecture may access the database to determine what files should be retrieved from a download site associated with the virtual space. These files may be downloaded separately or in a compressed file, as described above.

Additionally, the look of the gift bag interface 600 may change according to what files 610 it contains and/or what portion of the virtual space a user views at the time the gift bag 600 is accessed. For example, if the user is viewing a particular company's booth at a virtual tradeshow, opening the gift bag 600 may associate a first skin, appearance or graphic with the gift bag 600. This graphic may include, for example, a color scheme, name, or logo associated with the company.

One exemplary embodiment of the present invention maintains a pointer to, or indicator of, the last object shown in the virtual space. The embodiment may use this indicator in order to determine which graphic to associate with the gift bag 600. In alternative embodiments, the options available to a user viewing the gift bag 600 may change depending on the object or position indicated by the indicator. For example, a company may provide an exclusive video or audio clip accessible only through the gift bag 600, and then only when the user is viewing their booth or object.

VIII. Virtual Identification and Data Tracking

Users who access a virtual space in accordance with an exemplary embodiment of the invention may be asked to register with a server or other computing device associated with the virtual space. Access to the virtual space may be restricted until registration is completed. Once registered, the user may be issued a unique virtual identifier. In one exemplary embodiment where the virtual space replicates a tradeshow, the virtual identifier may take the form of a “virtual badge” similar to badges given out at real-world tradeshows. The virtual identifier may include a user's name, company, address, and so forth.

As the user navigates the virtual space and visits booths (or other objects), watches media displays such as video or audio clips, and/or selects certain files for download, the embodiment may store in a database the booths visited, media watched, files downloaded and so forth. Because the user has a virtual identifier associated with him or her, the embodiment may also store the identifier and/or any registration information associated with the user in the database along with the activities undertaken in the virtual space (i.e., visiting objects, downloading files, watching media, and so forth).

Thus, for a given user, the embodiment may compile a data set indicating what the user has done in the virtual space. Likewise, for a given activity, object, file, media clip and so on (collectively, “element”), the embodiment may track which users interact with the activity or element. The embodiment may further track whether an element such as a media clip was watched in its entirety or only partway through using the Flash cookie described above.

Owners, implementers and operators of the virtual space (collectively, “owners”) may use the data tracking capabilities of the exemplary embodiment in a number of ways. For example, owners may sell or otherwise provide demographic information to companies sponsoring or associated with certain objects or elements in order to inform the company how popular the particular element was. Owners may provide additional content in the virtual space that mirrors previously-provided popular content in order to enhance the virtual space. Owners may employ demographic data to determine if certain portions of the virtual space are particularly popular with certain demographics, such as men, women, people employed by a particular company, and so forth. The embodiment may likewise track the time at which any registered user interacts with or visits an element so that owners may see if the virtual space is accessed more frequently at certain times.

Registration of users with a computing device associated with the virtual space may unlock additional features and advantages for the user. For example, an owner of the virtual space, or company associated with an element of the space or the space itself, may sponsor a virtual sweepstakes. As a non-limiting example, such a sweepstakes may require a user to view a certain number of booths or objects or specific booths/objects. Likewise, a user may have to select or actually download certain files or a number of files. Once the conditions of the sweepstakes are met, the user may be entered in the sweepstakes to win a prize. The embodiment may retrieve the registration information supplied by the user from the user's virtual identifier in order to enter the user in the sweepstakes. Alternatively, the embodiment may confirm the user has registered as a condition of entry into the sweepstakes. Thus, only registered users may enter the sweepstakes and be eligible for whatever prizes are provided in the sweepstakes. In a similar manner, mailings (electronic or physical), updates, and information may be provided to a registered user if the user provided a physical mail or electronic mail address during the registration process.

Registration information provided by the user, or the virtual identifier of the user, may be stored as a standard browser cookie or a Flash cookie. In this manner the user may be recognized by an exemplary embodiment when the user again interacts with the virtual space. If the registration information/virtual identifier is stored as a Flash cookie, it may persist even if the user clears his or her cookies.

IX. Smart Loading

Due to the large number of assets that may be associated with a virtual space, certain embodiments of the present invention may employ an intelligent and configurable loading procedure or module. This intelligent loading procedure selectively assigns priorities to various assets, elements and other pieces of the virtual space and loads them starting with the most critical. In one exemplary embodiment, objects, object skins, and designated media are given higher priority over lower priority pieces such as transition movies, ambient animations, non-designated media and so forth. Moreover, since media streaming or downloading may place relatively heavy demands on bandwidth available to the user, particularly when the media is high-quality video, the embodiment may pause any active downloads if the user selects media to stream or download or the virtual space otherwise streams or downloads media to the user. Such downloads may resume as soon as the streaming or downloading media finishes or is aborted.

Additionally, in certain embodiments even if a user has not selected a downloadable element for download, the downloadable element may be downloaded by the embodiment in accordance with a priority assigned by the intelligent loading procedure. In this way, downloadable elements (including media clips) may be download to a user's computing device without unduly disrupting the user's experience in the virtual space.

X. Additional Applications

Exemplary embodiments of the present invention have been generally described with respect to a virtual space depicting a tradeshow or trade fair. Those of ordinary skill in the art will appreciate that any virtual space may be created and displayed in accordance with embodiments of the invention. For example, the interior or exterior of one or more buildings may be created as a virtual space. An embodiment of the invention may be used to model, for example, a server farm or other aggregate of computing devices within a space.

Further, due to the scalability and flexibility of the embodiment, additional parameters beyond positional data may be defined and specified in the XML file or other input file accessed by the engine to provide further functionality to a user. In the server farm example, the XML file may contain information corresponding to available power at a number of positions within the virtual space as well as information corresponding to the power consumption of each server in the server farm. Thus, a user may construct or step through a virtual space and, in addition to reviewing a virtual physical layout of the space, may also view or review a virtual power consumption and supply for given positions in the virtual space.

Additional parameters are not limited to power, but may include ambient lighting, water supply, ventilation and cooling, and so forth.

XI. Conclusion

Although the present invention has been described with particular reference to certain embodiments and processes, it should be understood that such embodiments and processes are illustrative rather than limiting. Alternative embodiments may change or omit certain processes and/or elements described herein. For example, one exemplary embodiment may have a single asset library. Another exemplary embodiment may omit cutscenes or media streaming. Accordingly, alternative embodiments and aspects of the invention will be obvious to those of ordinary skill in the art upon reading this disclosure. Such alternative embodiments are embraced by the spirit and scope of the present invention.

We claim:

1. A virtual space, comprising:
at least two objects configured to be rendered as a virtual space;
each of the at least two objects having associated assets defining attributes of the respective object;
each of the at least two objects comprising at least one of a block model and a wire frame, and a skin overlaying the block model or wire frame.

2. The virtual space of claim 1, wherein at least one of the assets comprises a downloadable element.

3. The virtual space of claim 1, wherein positions of the at least two objects are defined by a transition between the at least two objects.

4. The virtual space of claim 3, wherein:
the at least two objects comprises a first object and a second object; and
the transition comprises a door displayed with the first object, the second object being associated with the door and rendered in response to activation of the door.

5. The virtual space of claim 3, wherein the transition comprises a cutscene.

6. The virtual space of claim 1, wherein a class is associated with the block model or wire frame.

7. The virtual space of claim 6, wherein the class comprises at least one of a Flash class and a Java class.

8. The virtual space of claim 1, further comprising at least one media file associated with at least one of the objects, the media file being configured to at least one of stream and download upon user selection of a portion of the associated object.

9. An apparatus for implementing a virtual space, comprising:
an assets library including a plurality of assets associated with respective objects to be rendered as a virtual space;
an engine configured to access the assets from the asset library to generate the respective objects associated therewith and render the respective objects as the virtual space.

10. The apparatus of claim 9, wherein the assets library includes at least one of a block model and a wire frame, and a skin overlaying the block model or wire frame, for each of the respective objects.

11. The apparatus of claim 9, further comprising a loading module configured to assign priorities to the assets included in the asset library.

12. The apparatus of claim 9, further comprising at least one XML file separate form the asset library, the engine being configured to access assets from the separate XML file to generate the respective object associated therewith and render the respective objects as the virtual space.

13. The apparatus of claim 12, further comprising a loading module configured to assign priorities to the assets included in the asset library and the assets included in the separate XML file.

14. The apparatus of claim 9, wherein at least one of the plurality of assets comprises a downloadable element.

15. The apparatus of claim 14, further comprising a loading module configured to assign a priority to the downloadable element and to download the downloadable element based on the assigned priority.

16. The apparatus of claim 9, wherein the engine is configured to generate a user interface configured to display files downloaded via user interaction with the virtual space.

17. The apparatus of claim 16, wherein the user interface is configured to at least one of group the downloaded files, allow a user to sort the downloaded files, and allow a user to remove a file from the downloaded files.

18. A method of providing a virtual space, comprising:
accessing at least one of a block model and a wire frame;
accessing a skin associated with the block model or wire frame;
and rendering a first object by overlaying the block model or wire frame with the skin.

19. The method of claim 18, further comprising:
defining a second object by at least one of a block model and a wire frame, and a skin associated with the block model or wire frame;
defining a transition between the first object and the second object;
associating the transition with the second object; and
rendering the transition with the rendered first object.

20. The method of claim 19, further comprising:
receiving an activation of the transition from a user of the virtual space; and
rendering the second object in response to the activation of the transition.

21. The method of claim 20, further comprising rendering a cutscene in response to the activation of the transition prior to rendering the second object.

22. The method of claim 18, further comprising providing a downloadable element and associating the downloadable element with the first object.

23. The method of claim 22, wherein the downloadable element comprises a file, further comprising downloading the file in response to user interaction with the first object.

24. The method of claim 23, further comprising providing a user interface configured to display files downloaded via user interaction with the virtual space.

25. The method claim 24, further comprising at least one of sorting the downloaded files and removing a file from the downloaded files in response to user input via the user interface.
